(19) United States
(12) Patent Application Publication
(10) Pub. No.: US 2006/0131322 A1
(43) Pub. Date: Jun. 22, 2006

(54) Packaged product vending machine

(75) Inventors: Sergio Pesenti Barili, Stezzano, Bergamo (IT); Aristide Domenico Roncari, Milano (IT)

Correspondence Address: WENDEROTH, LIND & PONACK, L.L.P., 2033 K STREET N. W., SUITE 800, WASHINGTON, DC, 20006-1021, US

(73) Assignee: Necta Vending Solutions S.p.A., Valbrembo, Bergamo (IT)

(21) Appl. No.: 10/536,019

(22) PCT Filed: Sep. 23, 2003
(86) PCT No.: PCT/EP03/10562

§ 371 Date: Nov. 16, 2005

(30) Foreign Application Priority Data
Nov. 21, 2002 (IT) PN2002U000055

(51) Int. Cl. G07F 11/00

(52) U.S. Cl. 221/85

(57) ABSTRACT

Packaged-product vending machine comprising a bearing structure (2) provided with an access door (3) and a storage compartment (4) in which there is mounted at least a tray (5) adapted to hold the products to be delivered into a dispensing compartment (6) that is accessible from the outside for collecting the vended products, in which said tray (5) is associated by means of sliding means (8) to side runners (7) so as to be able to be pulled out to a product-loading position, said tray (5) being further connected to said sliding means (8) by means of coupling means (9) that are capable of oscillating between a first position, in which said tray (5) is in a horizontal condition, and a second position, in which said tray (5) is in its product-loading position in a forwards and downwards inclined condition.

The present invention refers to a vending machine for packaged products.

Vending machines of such a kind are generally constituted by a bearing structure that defines a storage compartment, in which the products to be vended are capable of being arranged, and a dispensing compartment, which accessible from the outside for picking up the vended products and into which said products are therefore unloaded upon them having been selected by a buyer. The storage compartment is closed by means of an access door, which may be conveniently glazed so as to enable the products available for vending to be properly viewed from the outside, wherein said products are arranged on appropriate trays or shelves. These trays are generally arranged upon each other, are attached to the storage compartment by means of sliding runners, and are open on the front side so as to enable the selected products to fall into the dispensing compartment, in a manner that is substantially known as such in the art. The trays are generally adapted to slide along their runners in such a manner as to be able to be pulled out of the storage compartment up to an end-stop, i.e. farthest allowable extracted position, in which they protrude horizontally from the storage compartment with almost the entire longitudinal dimension thereof, while remaining associated to the sliding runners in correspondence of the rear tray portion. This is the position in which the trays can be replenished by putting in the products that have in the meanwhile run out of stock. Some vending machines are even so designed as to allow for the trays being arranged on top of the storage room to be capable of being pulled out into a downward-sloping loading position, so as to make it more convenient for products to be placed thereupon, whereas the lower trays remain horizontal when pulled out. Usually, such an inclination of the upper trays is obtained by making use of sliding runners which, in correspondence of their end sections facing the inlet or entrance side of the storage room are provided with a rail having a substantially step-like profile enabling the sliding means of the tray to displace upwardly. As a result, when the tray is pulled out into the loading position thereof, it is able to incline downwards under the effect of its own weight, since the sliding means, upon reaching said step, are in fact allowed to slightly move upwards, i.e. lift jointly with the rear portion of the tray which they are associated to.

A drawback that is typically connected with the above-cited kind of vending machines derives from the fact that two types of sliding runners, differing from each other as far as their construction is concerned, must in fact be used in this case, i.e. a simple one and one that is provided with said step to tray tilting purposes, so as to enable the trays to be pulled out to their loading position in a horizontal and a downwardly inclined condition, respectively, as the case may be. This practically implies that, for the loading position of the trays to be possibly modified, the need arises, for example, for the pair of horizontal pull-out runners of the tray to be replaced with a corresponding pair of downward-sloping pull-out runners. In addition, two different kinds of runners are an added complication as far as both the production cycle and the assembly are concerned.

It therefore is the object of the present invention to provide a packaged-product vending machine, which does away with the drawbacks of prior-art machines of this kind.

Within this general object, it is a purpose of the present invention to provide a tray which is such as to make it simpler to change over from a loading position in a horizontal condition of the tray to a loading position in which the tray is on the contrary inclined downwards.

Another purpose of the present invention is to provide a tray and a related runner, which are simple to make and reliable to use.

Another purpose yet of the present invention is to provide a vending machine which is simpler in its construction, easier and more convenient to assemble, as well as capable of being produced at more competitive costs.

A further purpose of the present invention is to provide a vending machine, in which the size of the tray relative to the available space inside the storage compartment of the machine is not affected by the space requirement of the runners.

According to the present invention, these aims, along with further ones that will become apparent in the following description, are reached in a packaged-product vending machine incorporating the features and characteristics as recited in the appended claims 1 to 12.

Features and advantages of the present invention will anyway be more readily understood from the description of the structure of the invention that is given below by way of non-limiting example with reference to the accompanying drawings, in which:

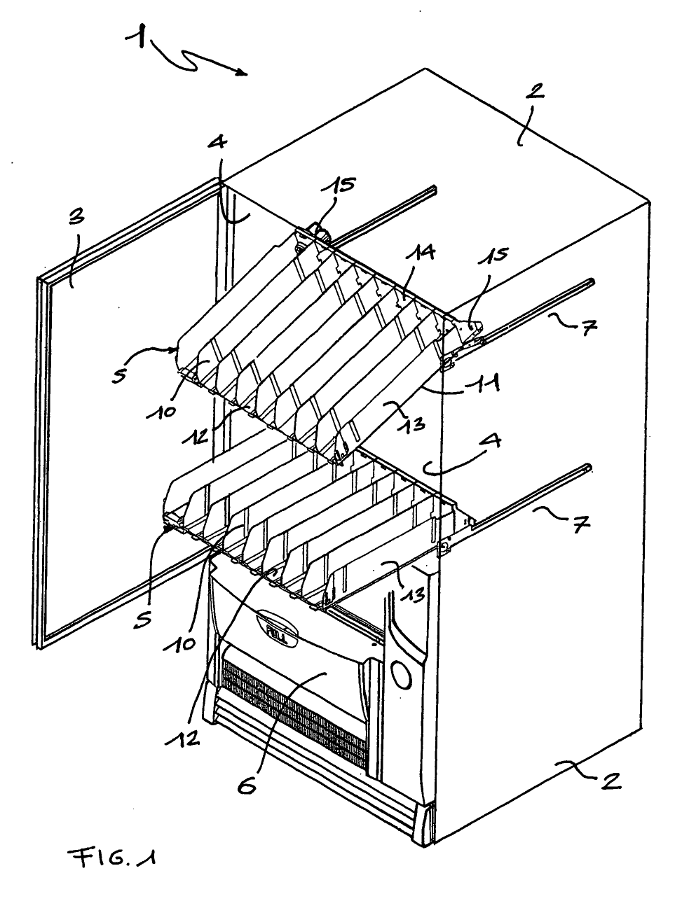

FIG. 1 is a perspective view of a packaged-product vending machine according to the present invention, illustrating both positions in which the tray can be pulled out;

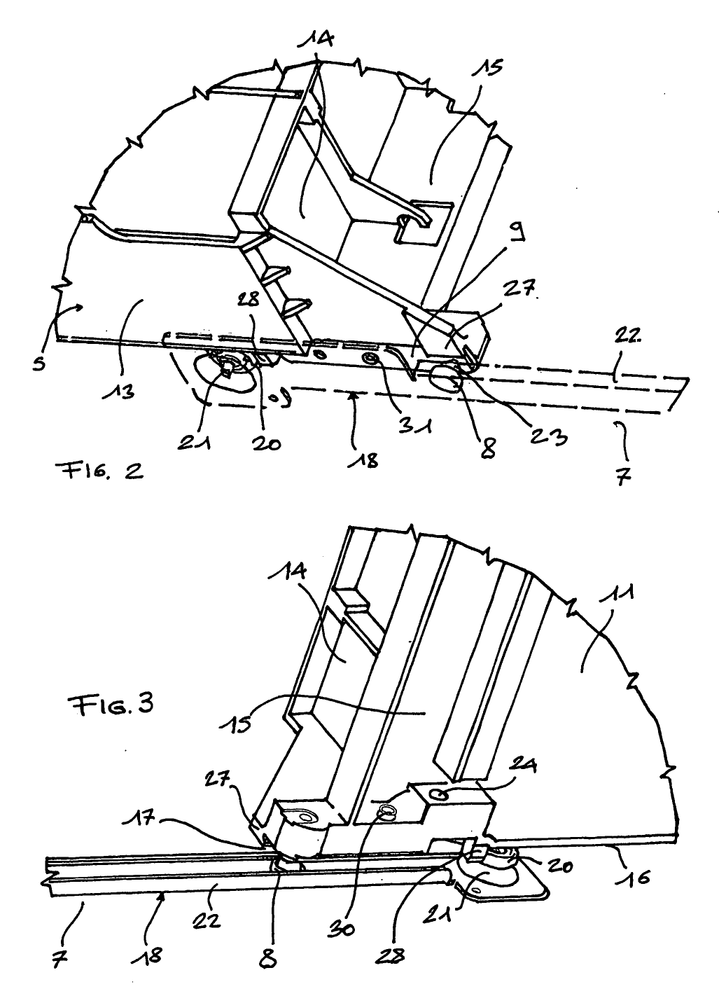

FIG. 2 is a perspective top view of the sliding and coupling means, which are illustrated in detail in the condition in which the tray is pulled out horizontally;

FIG. 3 is a perspective bottom view of the sliding and coupling means, which are illustrated in detail in the condition in which the tray is pulled out horizontally;

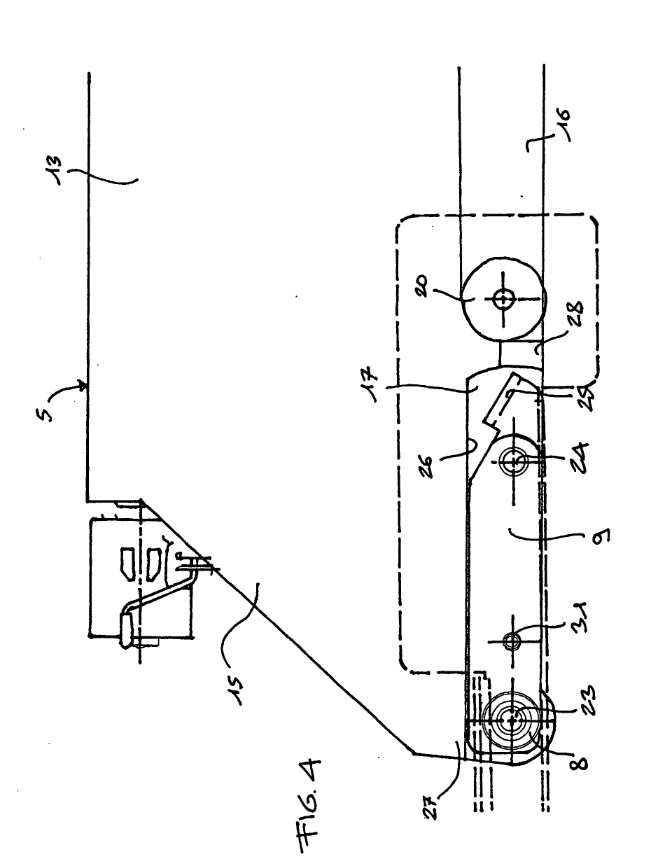

FIG. 4 is a side elevational view of the sliding and coupling means, which are illustrated in detail in the condition in which the tray is pulled out horizontally;

FIG. 5 is a view similar to the one appearing in FIG. 2, but in the condition in which the pulled-out tray is inclined downwards;

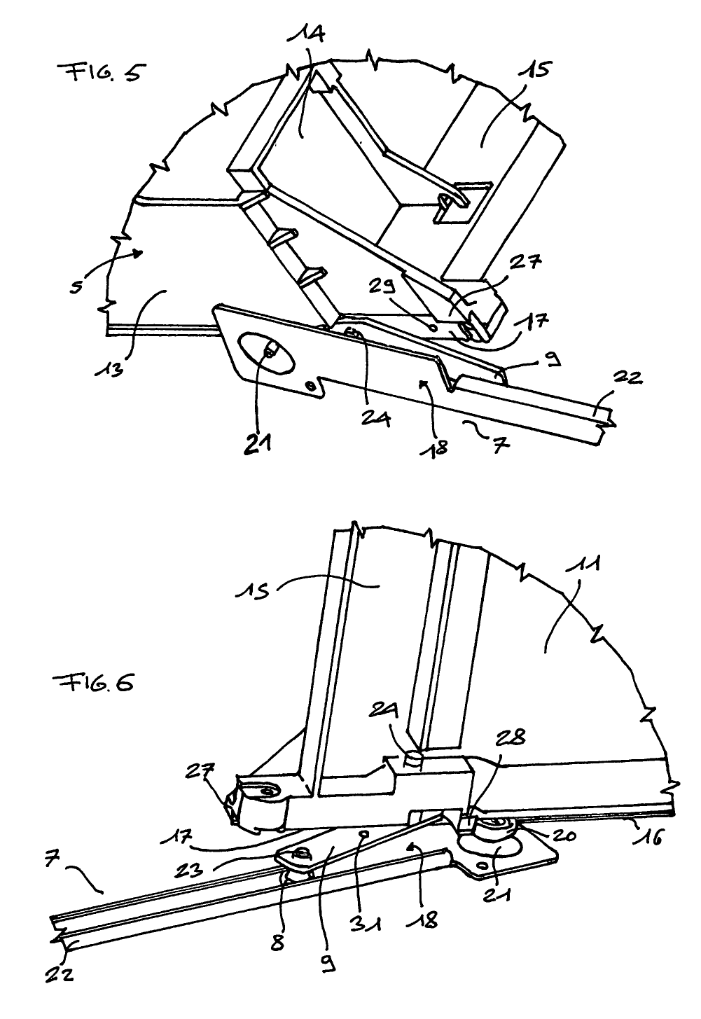

FIG. 6 is a view similar to the one appearing in FIG. 3, but in the condition in which the pulled-out tray is inclined downwards;

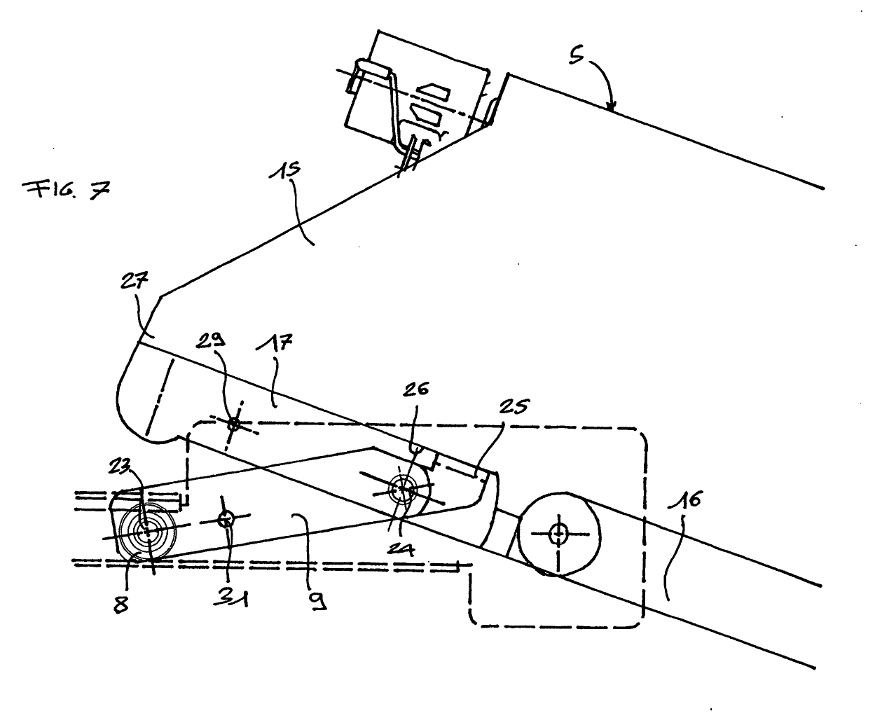

FIG. 7 is a view similar to the one appearing in FIG. 4, but in the condition in which the pulled-out tray is inclined downwards;

FIG. 8 is a side elevational view of the tray shown in a horizontal position inside the storage compartment;

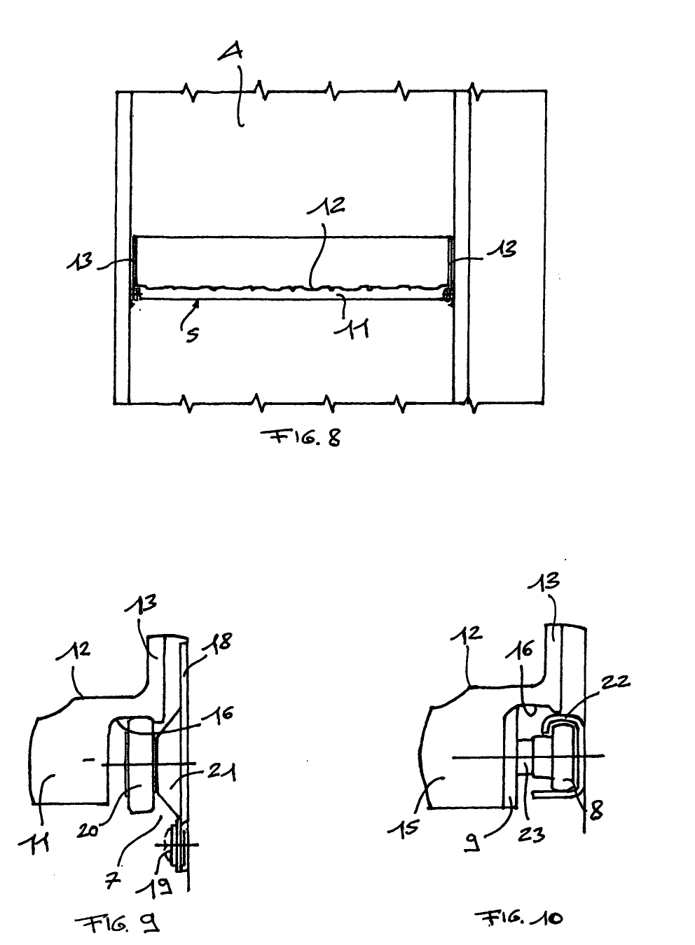

FIG. 9 is an enlarged side elevational view illustrating in detail the front side of the runner and the tray inside the storage compartment;

FIG. 10 is an enlarged side elevational view illustrating in detail the rear side of the runner and the tray inside the storage compartment.

With reference to the above-cited Figures, the packaged-product vending machine, which is indicated generally at 1, comprises a bearing structure 2 provided with an access door 3 for reaching into a storage compartment 4 holding a plurality of trays 5 arranged upon each other, on which there are arranged the products to be vended, which can then be unloaded into a dispensing compartment 6 that is accessible from the outside for the vended products to be picked up upon having been selected by a buyer. The trays 5 are associated to side runners 7 by means of sliding means 8, so as to be able to be pulled out up to a loading position, i.e. a position provided to load the products onto the trays.

According to the present invention, there are provided oscillating coupling means 9 that connect the tray 5 with the sliding means 8 so as to enable that tray to be pulled out into the loading position thereof either in a horizontal condition or in a condition in which it is inclined downwards on the front, depending on the needs of the user, as this shall be described in greater detail further on.

Each tray 5 is constituted by a box-shaped body subdivided into a plurality of compartments by vertical partition webs 10, open frontally so as to enable the vended products to fall into the dispensing compartment 6, in a manner that is known as such in the art, and open on top so as to enable the products to be placed in the various product-holding compartments of the tray. The tray 5 comprises a bottom plate 11 that defines on top a useful resting surface 12 for the packaged products to lie thereupon, and is delimited longitudinally by side walls 13, which define the maximum cross-dimension of the tray 5, and a rear wall 14. Beyond the rear wall 14 thereof, the tray 5 has a kind of extension of its side walls 13 and the resting surface 12, which define a support profile 15, in correspondence of which there are positioned the coupling means 9 and the sliding means 8. In correspondence of the joining seams between the side walls 13 and the resting surface 12, and beneath the latter, the bottom plate 11 shows a fall-off, i.e. a reduction in its cross-dimension, which defines on both sides a tapering step 16 along the entire longitudinal dimension of the tray 5, as this is best shown in FIG. 9. This step 16 creates a horizontal sliding surface adapted to couple with the side runners 7, as this will be described in greater detail further on. The step 16 extends beyond the rear wall 14, thereby defining on the support profile 15 an accommodating recess 17 adapted to receive and accommodate the coupling means 9 within the cross-dimension of the tray 5 so as to prevent them from protruding beyond the side walls 13 of the same tray, as this is best shown in FIG. 10.

Each side runner 7 is constituted by a lath-like body 18 associated to the bearing structure 2 inside the storage compartment 4 by means of rivets 19 or the like, in which said lath-like body comprises on the front a rotating member 20 revolving on a vertical plane and hinged on a pin 21 provided on the same lath-like body 18, whereas on the remaining longitudinal section thereof said lath-like body 18 is provided with bent edges 22 adapted to define a track along which the sliding means 8 of the tray 5 are associated displaceably.

The tray 6 is capable of sliding along the side runners 7 by means of the horizontal surfaces provided by the steps 16, which rest slidably on the rotating members 20, and through the sliding means 8 that are restrained to displace longitudinally inside the track of the runner 7. The rotating members 20 substantially occupy, i.e. take up the space within the tapering step 16, thereby being restricted within the maximum cross-dimension of the tray 5.

Each one of said sliding means 8 comprises a small wheel or roller that is associated to the tray 5 in an articulated manner by means of the coupling means 9, which are constituted by a connecting rod capable of oscillating between two extreme positions, in a first one of which the tray 5 and the connecting rod 9 are in a horizontal position, and in a second one of which the tray 5 is in a forwards and downwards inclined condition when pulled out in its loading position, while the connecting rod 9 is inclined upwards.

The roller 8 is rotatably connected to the connecting rod 9 through a guide pin 23 attached at an end portion of the latter. While at the opposite end portion thereof the connecting rod 9 is hinged on to a rocker pin 24 that is housed horizontally in the support profile 15 in correspondence of the accommodating recess 17, as best illustrated in FIGS. 4 and 7. The end portion of the connecting rod 9 that is hinged on to the tray 5 is so shaped as to form a kind of detent pawl 25 adapted to define, in cooperation with a corresponding abutment edge 26 provided on the upper surface of the step 16 defining the accommodating recess 17, a maximum downwards inclination of the tray 5 when pulled out in its loading position, while the connecting rod 9 is in the second extreme position of oscillation thereof.

With the tray 5 in a horizontal condition, the connecting rod 9 comes to lie horizontally in the accommodating recess 17, where it bears against an abutment step 27 defined laterally on the support profile 15. The support profile 15 further comprises a retaining tooth 28, which separates the sliding surface of the step 16 and the accommodating recess 17 of the connecting rod 9 from each other, and which is adapted to determine an end-stop or farthest allowable pull-out position of the tray 5 relative to the runner 7.

The accommodating recess 17 is passed through transversally by a bore 29 provided in the support profile 15 and adapted to movably receive a selection pin 30, which is movable in said through-bore 29 to reversibly engage a corresponding locking aperture 31, provided in the connecting rod 9 and aligned with said through-bore 29, when the connecting rod 9 is in a horizontal condition, so as to prevent any relative displacement of the tray 5 and the connecting rod 9 relative to each other, as this is illustrated in detail in FIGS. 4 and 7.

When the tray is pulled out of the storage compartment 4 of the vending machine, each one of the tapering steps 16 slides on the rotating member 20 of the side runners 7, and the rollers 8 displace along the tracks defined by the side runners 7, while the connecting rods 9 lie in a horizontal condition in the accommodating recesses 17 thereof bearing against the abutment steps 27. Owing to the particular configuration in the construction of the bottom plate 11, the rotating member 20 and the roller 8 are substantially contained within the side bulk of the tray 5, i.e. do not protrude from the tray 5 laterally, in such a manner that the side walls 13 are able to slide longitudinally flush with the wall of the storage compartment 4, as this can be most clearly noticed in FIGS. 8 to 10. The tray 5 is able to slide outwardly until the retaining tooth 28 eventually abuts against the rotating member 20, thereby defining the farthest pull-out distance of the tray 5 from the storage compartment 4 that can be obtained in order to conveniently load the products to be vended thereupon.

The two loading positions of the tray 5 are obtained in the manner as described below.

In the case where the selection pin 30 is inserted in the through-bore 29 so as to protrude from the accommodating recess 17 and engage the locking aperture 31 of the connecting rod 9, the tray 5 is pulled out in its loading position in a horizontal condition and the connecting rod 9 lies in its first extreme oscillation position, which is also horizontal. In fact, the selection pin 30 does not allow for any inclination to occur between the tray 5 and the connecting rod 9 with respect to each other, wherein both said tray and said connecting rod are solely allowed to displace translatorily by sliding along the runners 7.

If the locking aperture 31 is on the contrary not engaged by the selection pin 30, the tray 5 and the connecting rod 9 are allowed to perform a rotational movement that brings about the downward inclination of the tray 5. In other words, as it is progressively pulled out to reach its end-stop position, the tray 5 is free to incline downwards, owing to the effect of its own weight, by rotating about the rotating member 20 and carrying the connecting rod 9 with it via the rocker pin 24. The connecting rod 9 substantially rotates, in the opposite direction with respect to the tray 5, about the guide pin 23, which moves translatorily, jointly with the roller 8, along the runner so as to follow and conform to the displacement of the connecting rod 9. As soon as the detent pawl 25 comes into bearing against the abutment edge 26 of the accommodating recess 17, both the tray 5 and the connecting rod 9 are prevented from performing any further rotation. The tray 5 comes therefore to lie in its loading position in an inclined condition, while the connecting rod 9 reaches its second extreme oscillation position.

In an advantageous manner, the selection pin 30 may be displaced in the through-bore 29 provided in the support profile 15 so as to engage or not engage the locking aperture 31 of the connecting rod 9, thereby creating the conditions for alternatively pulling out the trays into a horizontal or an inclined loading position, as desired.

Fully apparent from the above description is therefore the ability of the the present invention to effectively reach the afore cited aims and advantages by providing a vending machine that is particularly simple from both a construction and an assembly point of view.

In particular, an advantageous feature of the present invention lies in that a tray is provided, which can be selectively pulled out into a horizontal or an inclined loading position, depending on the actual needs of the user, while sliding on the same kind of runners.

Another advantageous feature of the present invention is to provide a tray in which the space taken up by the runners is substantially integrated within the cross-dimension of the tray.

It will be readily appreciated that the above-described vending machine may be subject to a number of modifications and variants without departing from the scope of the present invention. It should further be noticed that the materials used, as well as the shapes and the sizing of the individual items, may each time be selected so as to more appropriately meet the particular requirements or suit the particular application, again without departing from the scope of the present invention.

1. Packaged-product vending machine comprising a bearing structure (2) provided with an access door (3) and a storage compartment (4) in which there is mounted at least a tray (5) adapted to hold the products to be delivered into a dispensing compartment (6) that is accessible from the outside for collecting the vended products, inside the storage compartment (4) said bearing structure (2) comprises side runners (7) each one being adapted to define a track, the tray (5) being capable of sliding along the side runners (7) through sliding means (8) restrained to displace longitudinally inside the track, so that the tray (5) is able to be pulled out up to a product-loading position in which the tray (5) protrudes horizontally from the storage compartment, characterized in that said tray (5) is further connected to said sliding means (8) by means of coupling means (9) that are capable of oscillating between a first position, in which said tray (5) is in a horizontal condition, and a second position, in which said tray (5) is in its product-loading position in a forward and downward inclined condition.

2. Vending machine according to claim 1, characterized in that each tray (5) comprises a bottom plate (11) that defines on top a useful resting surface (12) for the packaged products to lie thereupon, and is delimited longitudinally by side walls (13), which define the maximum cross-dimension of the tray (5), and a rear wall (14), the tray (5) comprising, beyond said rear wall (14) thereof, an extension of its side walls (13) and the resting surface (12), which define a support profile (15), in correspondence of which there are positioned said coupling means (9) and said sliding means (8).

3. Vending machine according to claim 1, characterized in that, in correspondence of the joining seams between said side walls (13) and said resting surface (12), and beneath the latter, said bottom plate (11) has a fall-off, i.e. a reduction in its cross-dimension, which defines on both sides a tapering step (16) along the entire longitudinal dimension of said tray (5), in which said step (16) provides a horizontal sliding surface adapted to couple with said side runners (7), said step (16) extending beyond said rear wall (14), thereby defining on said support profile (15) an accommodating recess (17) adapted to receive and accommodate said coupling means (9) within the cross-dimension of said tray (5) so as to prevent them from protruding beyond said side walls (13) of the same tray.

4. Vending machine according to claim 1, characterized in that each one of said side runners (7) comprises a lath-like body (18) associated to said bearing structure (2) by means of rivets (19), in which said lath-like body (18) comprises on the front side a rotating member (20) revolving on a vertical plane and hinged on a pin (21) formed by said lath-like body (18), bent edges (22) being provided all along the remaining longitudinal section of said lath-like body (18) in which said bent edges (22) are adapted to define a track along which said sliding means (8) are associated displaceably.

5. Vending machine according to claim 1, characterized in that said horizontal surfaces provided by said steps (16) rest slidably on said rotating members (20), in which said rotating members (20) are substantially contained in said tapering steps (16), thereby being restricted within the maximum cross-dimension of the tray (5).

6. Vending machine according to claim 1, characterized in that each one of said sliding means (8) comprises a small wheel, or roller, associated to the tray 5 in an articulated manner by means of the coupling means (9), said coupling means (9) comprising a connecting rod that is capable of oscillating between two extreme positions, in a first one of which said tray (5) and said connecting rod (9) are in a horizontal condition, and in the second one of which said tray (5) is in a forward and downward inclined condition when pulled out in its loading position, while said connecting rod (9) is inclined upwards.

7. Vending machine according to claim 1, characterized in that said roller (8) is rotatably connected to said connecting rod (9) through a guide pin (23) attached at an end portion thereof, at the opposite end portion thereof said connecting rod (9) being hinged on to a rocker pin (24) that is housed horizontally in said support profile (15) in correspondence of said accommodating recess (17), in which said second end portion of said connecting rod (9) is so shaped as to provide a detent pawl (25) adapted to define, in cooperation with a corresponding abutment edge (26) provided by the upper surface of said accommodating recess (17), a maximum downward inclination of the tray (5) when pulled out in its loading position, while said connecting rod (9) is in said second extreme position of oscillation thereof.

8. Vending machine according to claim 1, characterized in that in said first extreme position of oscillation thereof, said connecting rod (9) comes to lie horizontally along said accommodating recess (17), where it bears against an abutment step (27) defined laterally on said support profile (15), said support profile (15) further comprising a retaining tooth (28), which separates the sliding surface of said step (16) from said accommodating recess (17) of the connecting rod (9), and which is adapted to determine an end-stop or farthest allowable pull-out position of said tray (5) relative to said runner (7).

9. Vending machine according to claim 1, characterized in that said accommodating recess (17) is passed through transversally by a through-bore (29) provided in said support profile (15) and adapted to movably receive a selection pin (30), which is movable in said through-bore (29) to reversibly engage a corresponding locking aperture (31), provided in said connecting rod (9) and aligned with said through-bore (29), when said connecting rod (9) is in a horizontal condition, so as to prevent any relative displacement of said tray (5) and said connecting rod (9).

10. Vending machine according to claim 1, characterized in that in the case where said selection pin (30) engages said locking aperture (31) of said connecting rod (9), said tray (5) is capable of being pulled out to its loading position in a horizontal condition and said connecting rod (9) lies in its first extreme oscillation position, said selection pin (30) not allowing for any inclination to occur between said tray (5) and said connecting rod (9) relative to each other.

11. Vending machine according to claim 1, characterized in that when said locking aperture (31) is not engaged by said selection pin (30), said tray (5), when being pulled out, is free to incline downwards, owing to the effect of its own weight, by rotating in a clockwise direction about said rotating member (20) and carrying said connecting rod (9) with it via said rocker pin (24), said connecting rod (9) substantially rotating in an anti-clockwise direction about said guide pin (23), thereby moving translatorily, jointly with said roller (8), along said runner (7) so as to follow and conform to the displacement of said connecting rod (9), and coming eventually into bearing against said abutment edge (26) of said accommodating recess (17), thereby preventing both said tray (5) and said connecting rod (9) from performing any further rotation, in which said tray (5) comes therefore to lie in its loading position in an inclined condition, while said connecting rod (9) reaches said second extreme position of oscillation thereof.

12. (canceled)

13. Vending machine according to claim 2, characterized in that, in correspondence of the joining seams between said side walls (13) and said resting surface (12), and beneath the latter, said bottom plate (11) has a fall-off, i.e. a reduction in its cross-dimension, which defines on both sides a tapering step (16) along the entire longitudinal dimension of said tray (5), in which said step (16) provides a horizontal sliding surface adapted to couple with said side runners (7), said step (16) extending beyond said rear wall (14), thereby defining on said support profile (15) an accommodating recess (17) adapted to receive and accommodate said coupling means (9) within the cross-dimension of said tray (5) so as to prevent them from protruding beyond said side walls (13) of the same tray.

14. Vending machine according to claim 2, characterized in that each one of said side runners (7) comprises a lath-like body (18) associated to said bearing structure (2) by means of rivets (19), in which said lath-like body (18) comprises on the front side a rotating member (20) revolving on a vertical plane and hinged on a pin (21) formed by said lath-like body (18), bent edges (22) being provided all along the remaining longitudinal section of said lath-like body (18) in which said bent edges (22) are adapted to define a track along which said sliding means (8) are associated displaceably.

15. Vending machine according to claim 3, characterized in that each one of said side runners (7) comprises a lath-like body (18) associated to said bearing structure (2) by means of rivets (19), in which said lath-like body (18) comprises on the front side a rotating member (20) revolving on a vertical plane and hinged on a pin (21) formed by said lath-like body (18), bent edges (22) being provided all along the remaining longitudinal section of said lath-like body (18) in which said bent edges (22) are adapted to define a track along which said sliding means (8) are associated displaceably.

16. Vending machine according to claim 2, characterized in that said horizontal surfaces provided by said steps (16) rest slidably on said rotating members (20), in which said rotating members (20) are substantially contained in said tapering steps (16), thereby being restricted within the maximum cross-dimension of the tray (5).

17. Vending machine according to claim 3, characterized in that said horizontal surfaces provided by said steps (16) rest slidably on said rotating members (20), in which said rotating members (20) are substantially contained in said tapering steps (16), thereby being restricted within the maximum cross-dimension of the tray (5).

18. Vending machine according to claim 4, characterized in that said horizontal surfaces provided by said steps (16) rest slidably on said rotating members (20), in which said rotating members (20) are substantially contained in said tapering steps (16), thereby being restricted within the maximum cross-dimension of the tray (5).

19. Vending machine according to claim 2, characterized in that each one of said sliding means (8) comprises a small wheel, or roller, associated to the tray 5 in an articulated manner by means of the coupling means (9), said coupling means (9) comprising a connecting rod that is capable of oscillating between two extreme positions, in a first one of which said tray (5) and said connecting rod (9) are in a horizontal condition, and in the second one of which said tray (5) is in a forward and downward inclined condition when pulled out in its loading position, while said connecting rod (9) is inclined upwards.

20. Vending machine according to claim 3, characterized in that each one of said sliding means (8) comprises a small wheel, or roller, associated to the tray 5 in an articulated manner by means of the coupling means (9), said coupling means (9) comprising a connecting rod that is capable of oscillating between two extreme positions, in a first one of which said tray (5) and said connecting rod (9) are in a horizontal condition, and in the second one of which said tray (5) is in a forward and downward inclined condition when pulled out in its loading position, while said connecting rod (9) is inclined upwards.

21. Vending machine according to claim 4, characterized in that each one of said sliding means (8) comprises a small wheel, or roller, associated to the tray 5 in an articulated manner by means of the coupling means (9), said coupling means (9) comprising a connecting rod that is capable of oscillating between two extreme positions, in a first one of which said tray (5) and said connecting rod (9) are in a horizontal condition, and in the second one of which said tray (5) is in a forward and downward inclined condition when pulled out in its loading position, while said connecting rod (9) is inclined upwards.
